(19) United States
(12) Patent Application Publication
(10) Pub. No.: US 2005/0058191 A1
(43) Pub. Date: Mar. 17, 2005

(54) Method and apparatus for detecting signal quality and recording medium storing program therefor

(75) Inventors: Jae-wook Lee, Osan-si (KR); Jae-seong Shim, Seoul (KR); Hyun-soo Park, Seoul (KR); Eing-seob Cho, Yongin-si (KR); Jung-hyun Lee, Seoul (KR); Eun-jin Ryu, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/901,447

(22) Filed: Jul. 29, 2004

(30) Foreign Application Priority Data
Sep. 16, 2003 (KR) 2003-64157

(51) Int. Cl. H04Q 1/20; H04B 17/00

(52) U.S. Cl. 375/224

(57) ABSTRACT

A method and apparatus for detecting signal quality, and a computer readable recording medium having embodied thereon a program to execute the method. In the method for detecting the quality of an input signal, an estimated signal is calculated from an input signal by using a predetermined filter coefficient, then the filter coefficient is updated to minimize a difference between the estimated signal and the input signal, and based on the updated filter coefficient, the quality of the input signal is calculated.

### CROSS-REFERENCE TO RELATED APPLICATIONS

This application claims the priority of Korean Patent Application No. 2003-64157, filed on Sep. 16, 2003, in the Korean Intellectual Property Office, the disclosure of which is incorporated herein in its entirety by reference.

### BACKGROUND OF THE INVENTION

1. Field of the Invention

The present invention relates to a method for measuring the quality of an input signal, and more particularly, to a method for measuring the quality of an input signal to confirm whether the input signal is capable of being restored to an original signal through signal processing.

2. Description of the Related Art

When a signal containing noise is received by a communication system and a data storage apparatus, it is necessary to determine whether or not the received signal is of high enough quality to be restored without error through signal processing to an original signal before transmission.

At this time, if the original data before transmission is known, it is possible to determine the presence of errors by comparing data actually obtained through signal processing with the original data, and by doing so, the quality of the signal can be evaluated. However, in most cases, the original data before transmission is not known, and it is difficult to evaluate the quality of an input signal.

FIG. 1 is a block diagram showing a conventional signal quality detector. As shown in FIG. 1, if external noise is added to a signal when the signal travels through a channel and is received, the conventional signal quality detector determines the quality of the signal by detecting a jitter value. Jitter expresses, as a percentage, the degree of change of a received signal on a time axis, and expresses the quality of a signal of a storage device.

Meanwhile, in order to transmit more data within a limited transmission bandwidth in a communication system and to store more data in a limited area in a storage device, complex signal processing algorithms for an adaptive equalizer and a viterbi detector came into use in a data detection process, supplanting the older signal processing method of simply determining the polarity of a signal.

In the system using such a complex signal processing algorithms, for the adaptive equalizer and the viterbi detector, the bit error rate (BER) after signal processing and the detected jitter value came to show dissimilar characteristics.

FIG. 2 is a BER graph when noise from radial tilt and tangential tilt is added from the outside when data is reproduced after being recorded on a 12 cm Blu-ray (BD) disk with a recording density of 31 GB. In FIG. 2, tilt values are plotted on the horizontal axis by the degree of deviation from the central axis, and BER values are plotted on the vertical axis. Referring to FIG. 2, the smallest BER value is shown at tilt 0 where no noise is added from the outside, and as tilt increases, the BER value increases.

FIG. 3 is a graph showing results of detecting jitter values by using the conventional jitter detection apparatus under the same conditions as in FIG. 2. In FIG. 3, tilt values are plotted on the horizontal axis by the degree of deviation from the central axis, and the quality of an input signal is plotted on the vertical axis as a percentage. Referring to FIG. 3, the smallest jitter value is detected at tilt 0, and as tilt increases, the jitter value increases, but the characteristics of FIG. 3 are different from the characteristics of the BER graph of FIG. 2. In addition, at tangential tilt −0.6 and +0.6 and radial tilt +0.6 and −0.6, where the quality of a signal is poor, the jitter value cannot be detected. Accordingly, measuring the quality of a signal by using jitter values is not appropriate for modern, advanced communication systems and storage apparatuses designed to transmit and store much larger amounts of data.

### SUMMARY OF THE INVENTION

According to an aspect of the present invention, a signal quality measuring method and apparatus, in which, by measuring the quality of an input signal based on the characteristic of a channel, a more accurate measurement of signal quality can be obtained than by the conventional method, and a recording medium having embodied thereon a computer program to execute the method are provided.

According to an aspect of the present invention, there is provided a method of detecting the quality of an input signal, including calculating an estimated signal from the input signal by using a predetermined filter coefficient, updating the filter coefficient so that a difference value between the estimated signal and the input signal is minimized, and based on the updated filter coefficient, calculating the quality of the input signal.

According to another aspect of the present invention, there is provided an apparatus for detecting the quality of an input signal, including, an estimated signal calculation unit which calculates an estimated signal from the input signal by using a predetermined filter coefficient; a filter coefficient calculation unit which updates the filter coefficient so that a difference value between the estimated signal and the input signal is minimized; and an input signal quality determination unit which, based on the updated filter coefficient, calculates the quality of the input signal.

According to still another aspect of the present invention, there is provided a computer readable recording medium having embodied thereon a computer program for executing a method of detecting the quality of an input signal, wherein the method includes, calculating an estimated signal from the input signal by using a predetermined filter coefficient, updating the filter coefficient so that a difference value between the estimated signal and the input signal is minimized, and based on the updated filter coefficient, calculating the quality of the input signal.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail exemplary embodiments thereof with reference to the attached drawings of which:

FIG. 1 is a diagram explaining a conventional method of detecting the quality of an input signal;

FIG. 2 is a graph showing a bit error rate (BER) when noise is added to an input signal;

FIG. 3 is a graph showing results of detecting the quality of a signal according to the conventional quality detection method;

FIG. 4 is a block diagram of an apparatus for detecting the quality of a signal according to an embodiment of the present invention;

FIG. 5 is a graph showing a filter coefficient change for each signal quality obtained according to the embodiment of FIG. 4;

FIG. 6 is another graph showing a filter coefficient change for each signal quality obtained according to the embodiment of FIG. 4;

FIG. 7 is a graph showing results of measuring the quality of a signal obtained according to the embodiment of FIG. 4;

FIG. 8 is a graph showing results of a simulation to determine the minimum number of taps of a filter used in an embodiment of the present invention;

FIG. 9 is a graph showing results of another simulation to determine the minimum number of taps of a filter used in an embodiment of the present invention; and

FIG. 10 is a flowchart of the operation of the signal quality detection apparatus shown in FIG. 4.

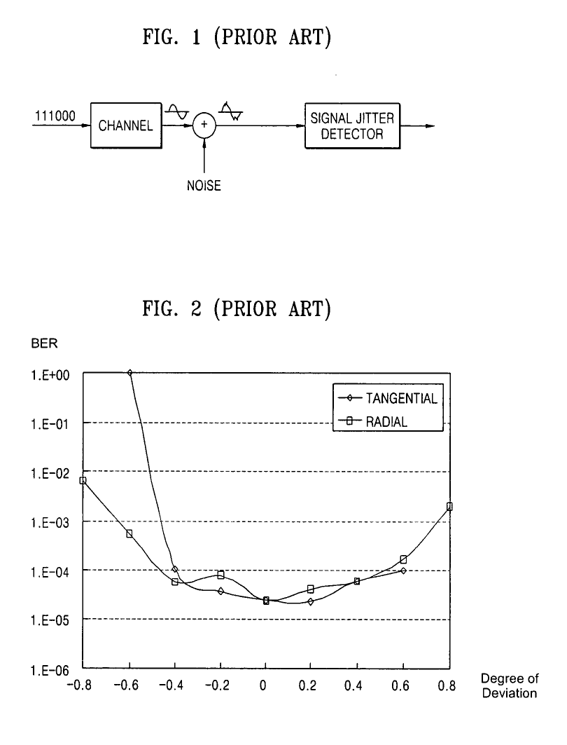

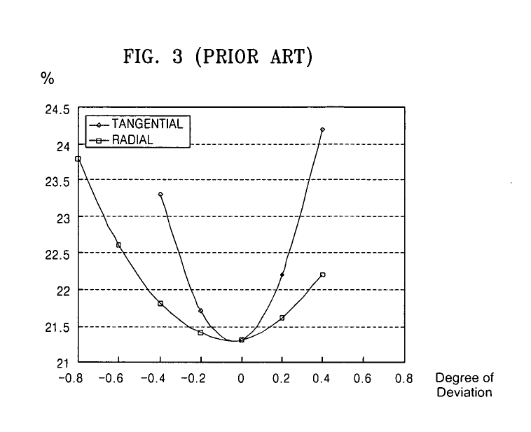

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

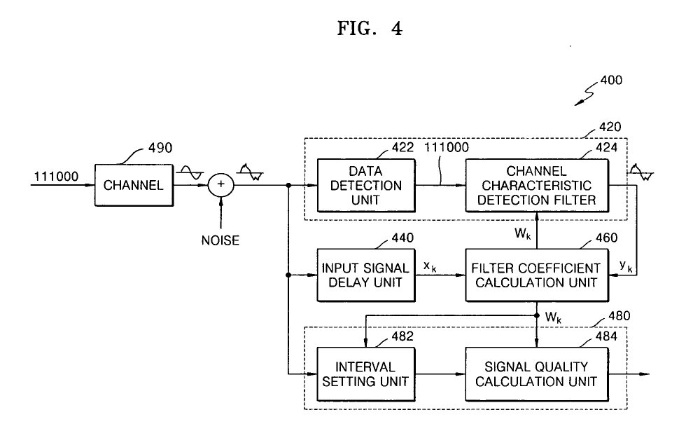

FIG. 4 is a block diagram of a signal quality detection apparatus according to an embodiment of the present invention. The signal quality detection apparatus 400 comprises an estimated signal calculation unit 420, an input signal delay unit 440, a filter coefficient calculation unit 460, and a signal quality determination unit 480. The estimated signal calculation unit 420 comprises a data detection unit 422 and a channel characteristic detection filter 424, and the signal quality determination unit 480 comprises an interval setting unit 482 and a signal quality calculation unit 484.

The data detection unit 422 converts an input RF signal from a channel 490 into digital data and outputs the digital data to the channel characteristic detection filter 424. The data detection unit 422 may use a slicer algorithm that distinguishes between 1 and 0 by considering only the polarity of a signal. Alternatively, it may use a complex signal processing algorithm in order to more accurately detect data. An appropriate algorithm for the data detection unit 422 is chosen in consideration of the complexity of a circuit and detection error, which is within the ordinary skill in the art and will not be described in detail.

The channel characteristic detection filter 424 converts the digital data input from the data detection unit 422 into an RF signal with the same form as the input signal, according to filter coefficient Wₖ input from the filter coefficient calculation unit 460. The channel characteristic detection filter 424 outputs an estimated RF signal Yₖ The method for calculating filter coefficient Wₖ will be explained in more detail below.

In order to generate a delayed RF signal Xₖ, the input signal delay unit 440 delays the input RF signal a time which is the amount of time taken from the input of the RF signal to the data detection unit 422, to the generation of the estimated RF signal yₖ in the channel characteristic detection filter 424, and outputs the signal xₖ to the filter coefficient calculation unit 460.

By using the difference between the estimated RF signal yₖ input from the channel characteristic detection filter 424, and the delayed input RF signal xₖ input from the input signal delay unit 440, the filter coefficient calculation unit 460 updates the filter coefficient Wₖ used in the channel characteristic detection filter 424 so that the estimated RF signal yₖ matches the delayed input RF signal xₖ as closely as possible.

In other words, in order to obtain the filter coefficient Wₖ used in measuring the quality of a signal, the difference between the delayed input RF signal xₖ and the estimated RF signal yₖ is obtained, and then the coefficient Wₖ is modified so that the difference can be minimized. And, this operation is performed repeatedly until the filter coefficient Wₖ converges. At this time, a method for converging a coefficient may involve a variety of adaptive equalization algorithms frequently used in signal processing theory. An appropriate algorithm is chosen in consideration of converging time, error, and the complexity of a circuit.

If the number of unit input signals reaches a predetermined value, by using the filter coefficient Wₖ from the filter coefficient calculation unit 460 and the input RF signal, the interval setting unit 482 determines that the filter coefficient Wₖ has converged, and outputs the result to the signal quality calculation unit 484. For example, if the number of channel bits reaches 2¹⁶, the interval setting unit 482 determines that the filter coefficient Wₖ has converged. Alternatively, a width variation of the filter coefficient Wₖ may be considered. For example, if the width variation of the filter coefficient Wₖ during a predetermined time period is within a predetermined range, it is determined that the filter coefficient Wₖ has converged.

When the result that the filter coefficient Wₖ has converged is received from the interval setting unit 482, the signal quality calculation unit 484 calculates a final signal quality by using the filter coefficient Wₖ input from the filter coefficient calculation unit 460, and outputs the result.

A function used by the signal quality calculation unit 484 is determined such that signal quality can be represented most characteristically in filter coefficient Wₖ for each signal quality in actual communication systems and storage apparatuses.

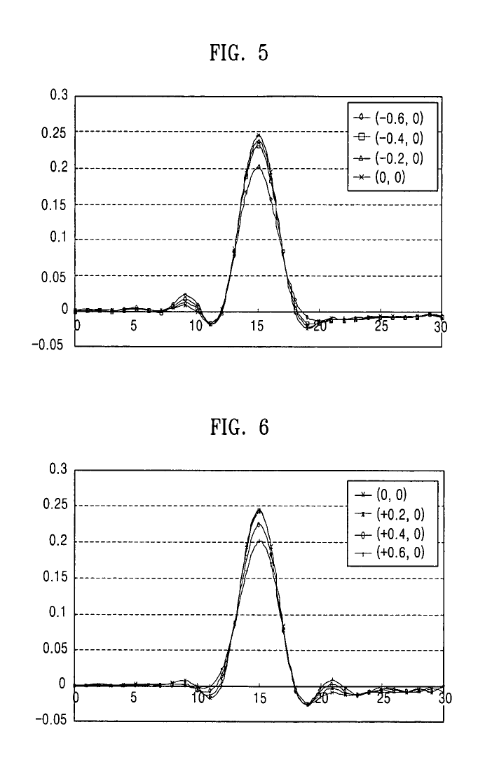

Aspects of the signal quality detection apparatus 400 shown in FIG. 4 will now be explained with reference to FIGS. 5 through 9.

FIG. 5 is a graph showing filter coefficient change for each signal quality obtained by using the signal quality detection apparatus 400 according to the above-described embodiment shown in FIG. 4. In FIG. 5, tap numbers used in the filter are plotted along the horizontal axis and the filter coefficients are plotted along the vertical axis.

FIG. 5 shows the filter coefficient change for each signal quality when a partial response maximum likelihood (PRML) detector is used as the data detector 422 of FIG. 4, a 31-tap finite impulse response (FIR) filter is used as the channel characteristic detection filter 424, and an LMS algorithm corresponding to the following Equations 1 and 2 is used:
eₖ=xₖ−yₖ (1)
Wₖ₊₁=Wₖ+2μeₖXₖ (2)
Here, eₖ denotes the difference value between the delayed input RF signal and the estimated RF signal, μ denotes a gain value to determine a compensation speed, and Xₖ denotes delay values corresponding to input RF signals.

At this time, the input signal used is obtained by adding noise corresponding to tangential tilt −0.6 through 0 when data is recorded with a density of 31 GB on a 12 cm Blu-ray (BD) disk used to obtain the data plotted in FIG. 2, and the data is reproduced.

FIG. 6 is a graph showing filter coefficient change for an input signal to which noise corresponding to tangential tilt 0 through 0.6 is added under the same conditions as when obtaining the data plotted in FIG. 5. In FIG. 6, tap numbers used in the filter are plotted along the horizontal axis and the filter coefficients are plotted along the vertical axis.

FIGS. 5 and 6 show that as the tilt value of the input signal increases, the value of a 15th tap, which corresponds to the centermost filter coefficient, gradually decreases. It can also be seen that, as the tangential tilt value increases negatively, the 6th through 10th tap values increase, and as the tangential tilt value increases positively, the 20th through 24th tap values increase.

Thus, the characteristic of a signal with respect to tilt is expressed in the sixth through tenth taps, the 15th tap, and the 20th through 24th taps. Accordingly, by reflecting these findings, Equation 3 expressing the quality of a signal is obtained. Equation 3 shows how much distortion has occurred compared to a reference gain.
SQ=k−{C₁₅+(C₆−C₇)+(C₆−C₈)+(C₆−C₉)+(C₆−C₁₀)}−{(C₂₄−C₂₀)+(C₂₄−C₂₁)+(C₂₄−C₂₂)+(C₂₄−C₂₃)} (3)
Here, SQ denotes a signal quality value and k is a constant. In the example aspect, k is set to 0.25.

In the embodiment of FIG. 4, the signal quality value of an input signal is calculated by using Equation 3. However, as shown in FIGS. 5 and 6, it is possible to construct an apparatus with a less complex operation circuit and, at the same time, improved accuracy, by selectively using values of the central tap and neighboring left side and right side taps that clearly show the characteristic of the input signal.

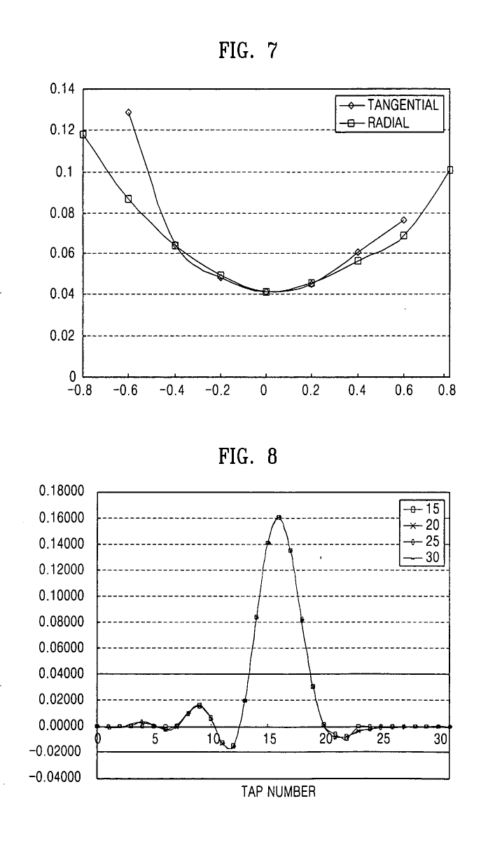

FIG. 7 is a graph showing results of measuring the quality of a signal obtained according to another embodiment of the present invention. In FIG. 7, tilt values are plotted along the horizontal axis, and signal quality values calculated with Equation 3 are plotted along the vertical axis.

FIG. 7 shows change in the signal quality value for each tilt when Equation 3 is applied to the signal quality calculation unit 484 of FIG. 4 and a converging interval in the interval setting unit 482 is set to 1 million data units of the input signal. The result of measuring the quality of a signal for each tilt of FIG. 7 produces a shape similar to the BER results of the actual detector shown in FIG. 2, with respect to signal quality.

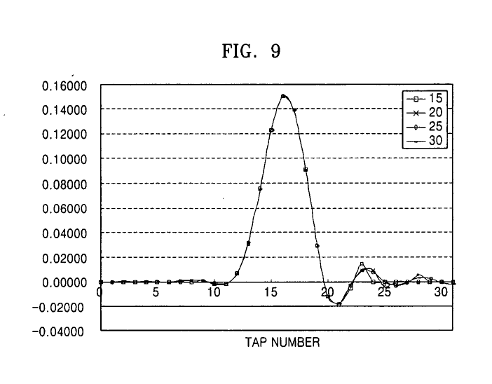

FIGS. 8 and 9 show results of a simulation performed to select a minimum number of taps required when the channel characteristic detection filter 424 of FIG. 4 is an FIR filter. In FIGS. 8 and 9, tap numbers are plotted along the horizontal axis and filter coefficients are plotted along the vertical axis. FIGS. 8 and 9 show that at least 19 taps are needed in order to express the sixth through tenth taps, the 15th tap, and the 20th through 24th taps, which clearly show the characteristic of the signal. The simulation shows that when the 15th tap, the 20th tap, the 25th tap, and the 30th tap are all considered, the results are the same, except in the 15th tap's case. The results of this simulation support the analysis result that at least 19 taps are needed.

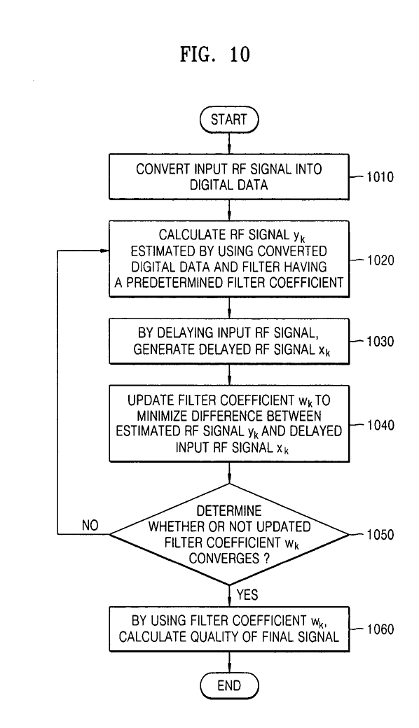

FIG. 10 is a flowchart of the operations performed in the signal quality detection apparatus 400 shown in FIG. 4.

In operation 1010, the input RF signal is converted into digital data. In operation 1020, the digital data converted in operation 1010 is converted into an RF signal like the input signal, by using a filter having a predetermined filter coefficient Wₖ and calculating an estimated RF signal yₖ. The method of calculating the filter coefficient Wₖ will now be explained in detail.

In operation 1030, the delayed RF signal xₖ is generated by delaying the input RF signal for the time taken from input of the input RF signal to generation of the estimated RF signal yₖ. In operation 1040, by using the difference between the estimated RF signal yₖ calculated in operation 1020, and the delayed input RF signal xₖ calculated in the operation 1030, filter coefficient Wₖ used as the filter coefficient in the channel characteristic detection filter is updated so that the estimated RF signal yₖ matches the delayed input RF signal xₖ as closely as possible.

In operation 1050, it is determined whether or not filter coefficient Wₖ updated in operation 1040 has converged.

If it is determined that filter coefficient Wₖ has converged, then operation 1060 is performed.

If it is determined that filter coefficient Wₖ is not converged, then the operation 1020 is performed again. In the operation 1020, based on filter coefficient Wₖ updated in operation 1040, the estimated RF signal yₖ is generated and then the next operation is performed.

In the above embodiment of the present invention, when the number of input RF signals reaches a predetermined value, that is, if the number of channel bits reaches 216, it is determined that the filter coefficient Wₖ has converged.

Alternatively, width variation of the filter coefficient Wₖ may be considered. For example, if the width variation of the filter coefficient Wₖ during a predetermined time period is within a predetermined range, the coefficient Wₖ is determined to have converged.

In operation 1060, if it is determined in operation 1050 that the filter coefficient Wₖ has converged, the final signal quality is calculated by using the filter coefficient Wₖ updated in operation 1040, and the result is output.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission over the Internet). The computer readable recording medium can also be distributed over network-coupled computer systems so that the computer readable code is stored and executed in a distributed fashion.

As described above, the method and apparatus for measuring the quality of an input signal according to the present invention measures the quality of an input signal based on the characteristics of a channel, such that a more accurate measurement of signal quality can be obtained than in the conventional art. Thus, the present invention can be effectively applied to next-generation communications systems and recording apparatuses for transmitting and recording increasingly larger amounts of data.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of detecting quality of an input signal, comprising:
calculating an estimated signal from the input signal by using a predetermined filter coefficient;
updating the filter coefficient such that a difference value between the estimated signal and the input signal is minimized; and
calculating the quality of the input signal based on the updated filter coefficient.

2. The method of claim 1, wherein the input signal is a radio frequency (RF) signal, and calculating the estimated signal comprises:
converting the input signal into digital data; and
calculating the estimated signal by using the converted digital data and the predetermined filter coefficient.

3. The method of claim 1, wherein the calculating the estimated signal, comprises using the updated filter coefficient.

4. The method of claim 1, wherein the updating the filter coefficient further comprises:
determining whether the updated filter coefficient has converged; and
the calculating the quality of the input signal further comprises:
calculating the quality of the input signal, based on a converged filter coefficient, when the updated filter coefficient has converged on a value.

5. The method of claim 4, wherein the determination of whether the updated filter coefficient has converged is based on whether a number of the input signal reaches a predetermined value.

6. The method of claim 4, wherein the determination of whether the updated filter coefficient has converged is based on whether a width variation of the filter coefficient stays within a preset range for a predetermined time period.

7. An apparatus for detecting quality of an input signal, comprising:
an estimated signal calculation unit which calculates an estimated signal from the input signal by using a predetermined filter coefficient;
a filter coefficient calculation unit which updates the filter coefficient such that a difference value between the estimated signal and the input signal is minimized; and
an input signal quality determination unit which calculates the quality of the input signal based on the updated filter coefficient.

8. The apparatus of claim 7, wherein the input signal is a radio frequency (RF) signal, and the estimated signal calculation unit comprises:
a data detection unit which converts the input signal into digital data; and
a channel characteristic detection filter which calculates the estimated signal by using the converted digital data and the predetermined filter coefficient.

9. The apparatus of claim 7, wherein the estimated signal calculation unit calculates the estimated signal by using the filter coefficient calculated by the filter coefficient calculation unit.

10. The apparatus of claim 7, wherein the filter coefficient calculation unit further comprises an input signal delay unit generating a delayed input signal, and based on the difference value between the delayed input signal and the estimated signal, calculates the filter coefficient.

11. The apparatus of claim 7, wherein the input signal quality determination unit further comprises:
an interval setting unit which determines whether the updated filter coefficient has converged; and
a signal quality calculation unit which, when the updated filter coefficient has converged on a value, calculates the quality of the input signal, based on the converged filter coefficient.

12. The apparatus of claim 11, wherein the interval setting unit determines whether the updated filter coefficient has converged, according to whether a number of the input signal reaches a predetermined value.

13. The apparatus of claim 11, wherein the interval setting unit determines whether the updated filter coefficient has converged, according to whether width variation of the updated filter coefficient stays within a preset range for a predetermined time period.

14. The apparatus of claim 8, wherein the channel characteristic detection filter has 19 taps.

15. A computer readable recording medium having embodied thereon a computer program for executing a method of detecting quality of an input signal, wherein the method comprises:
calculating an estimated signal from the input signal by using a predetermined filter coefficient;
updating the filter coefficient such that a difference value between the estimated signal and the input signal is minimized; and
calculating the quality of the input signal based on the updated filter coefficient.

16. The computer readable recording medium of claim 15, wherein the input signal is a radio frequency (RF) signal, and the calculating the estimated signal comprises:
converting the input signal into digital data; and
calculating the estimated signal by using the converted digital data and the predetermined filter coefficient.

17. The computer readable recording medium of claim 16, wherein the updated filter coefficient is used to calculate the estimated signal.

18. The computer readable recording medium of claim 15, wherein the updating the filter coefficient further comprises determining whether the updated filter coefficient has converged, and
the calculating the quality of the input signal further comprises calculating the quality of the input signal, based on the converged filter coefficient, if the updated filter coefficient converged on a value.

19. The computer readable recording medium of claim 18, wherein the determining of whether the updated filter coefficient has converged is based on whether a number of the input signal reaches a predetermined value.

20. The computer readable recording medium of claim 18, wherein the determining of whether the updated filter coefficient has converged is based on whether a width variation of the filter coefficient stays within a preset range for a predetermined time period.

21. A method of monitoring a quality of a channel signal, comprising:
generating an estimated signal from the channel signal from a filter coefficient;
delaying the channel signal by a time taken to generate the estimated signal, to result in a delayed channel signal;
minimizing a difference between the delayed channel signal and the estimated signal by adjusting the filter coefficient until convergence of the filter coefficient; and
determining the quality of the channel signal according to the adjusted filter coefficient at the convergence.

22. The method of claim 21, wherein the convergence corresponds to when the adjusting the filter coefficient stays within a set variance range over a period of time.

23. The method of claim 21, wherein the convergence corresponds to the channel signal reaching a set value.

24. A signal quality detection apparatus, comprising:
an estimated signal generator which generates an estimated signal based on a channel signal, the estimated signal is generated with a filter coefficient;
a delay which results in a delayed channel signal by retarding the channel signal for a predetermined period equal to a time required for the estimated signal generator to generate the estimated signal;
a filter coefficient generator which adjusts the filter coefficient to minimize a difference between the delayed channel signal and the estimated signal by adjusting the filter coefficient until convergence of the filter coefficient; and
a signal quality determination unit which calculates a final signal quality according to the filter coefficient at the convergence.

25. The apparatus of claim 24, wherein the signal quality determination unit determines the convergence of the filter coefficient when a set number of bits of the channel signal are received.

26. The apparatus of claim 24, wherein the signal quality determination unit determines the convergence of the filter coefficient when the filter coefficient generator adjusts the filter coefficient within a variance range for a predetermined time period.

27. The apparatus of claim 24, wherein the estimated signal generator comprises:
a converter which converts the channel signal to a digital channel signal; and
a channel characteristic filter which generates the estimated signal based on the digital channel signal and the filter coefficient.

28. The apparatus of claim 27, wherein the channel characteristic filter comprises at least 19 taps.

29. The apparatus of claim 27, wherein the channel characteristic filter comprises selected taps of a central tap corresponding to a centermost filter coefficient and an equal amount of taps on each side of the central tap.

30. The apparatus of claim 24, wherein the signal quality determination unit comprises:
an interval setting unit which determines whether the filter coefficient has converged; and
a signal quality calculation unit which calculates the final signal quality of the channel signal according to the filter coefficient at the convergence.

31. The apparatus of claim 24, wherein the channel signal is data reproduced from an information storage medium.

32. The apparatus of claim 31, wherein the information storage medium is a Blu-ray disc.

33. The apparatus of claim 24, wherein the channel signal is data received from a carrier wave.

34. A computer readable recording medium having embodied thereon a computer program for executing a method of detecting the quality of a channel signal, wherein the method comprises:
generating an estimated signal from the channel signal from a filter coefficient;
delaying the channel signal by a time taken to generate the estimated signal, to result in a delayed channel signal;
minimizing a difference between the delayed channel signal and the estimated signal by adjusting the filter coefficient until convergence of the filter coefficient; and
determining the quality of the channel signal according to the adjusted filter coefficient at the convergence.
